(19) United States
(12) Patent Application Publication
(10) Pub. No.: US 2015/0100436 A1
(43) Pub. Date: Apr. 9, 2015

(54) SYSTEM AND METHOD FOR COMBINING PAST USER EVENTS WITH REAL-TIME USER EVENTS TO RAPIDLY RESPOND TO ADVERTISING OPPORTUNITIES

(71) Applicant: MaxPoint Interactive, Inc., Morrisville, NC (US)

(72) Inventors: Jason Spofford, Austin, TX (US); Damien Harris, Austin, TX (US); Kurt Carlson, Austin, TX (US)

(73) Assignee: MaxPoint Interactive, Inc., Morrisville, NC (US)

(21) Appl. No.: 14/047,993

(22) Filed: Oct. 7, 2013

(51) Int. Cl. G06Q 30/02

(52) U.S. Cl. CPC G06Q 30/0275
USPC 705/14.71

(57) ABSTRACT

A system and method for combining past user events with real-time user events to respond to advertising opportunities is disclosed. According to one embodiment, a computer-implemented method includes receiving a first plurality of user events that occurred within a first prior time period, receiving a second plurality of user events that has occurred within seconds of real-time, and providing a plurality of desirable user events for consideration of a real-time bidding request based on processing the first plurality of user events and the second plurality of user events.

### FIELD

The present disclosure relates in general to the field of bidding on advertisement impressions based on user events. In particular, the present disclosure relates to a system and method for combining past user events with real-time user events to rapidly respond to advertising opportunities.

### BACKGROUND

An online advertisement impression generally refers to a slot or a space on a page of a web site that is available for displaying an advertisement along with its content. A user event for an advertisement impression generally refers to an active or passive action that a user provides in response to an advertisement impression such as clicking an image, expanding a display of an advertisement, and watching a video. Other user events can include, but are not limited to, indications that a user has visited one or more pages on a web site. Advertisers traditionally purchase advertisement impressions through bulk contracts with publishers. Recently, individually targeted advertisement impressions have become available through real-time bidding (RTB) exchanges such as ADX®, ADMELD®, PUBMATIC®, and RUBICON PROJECT®.

Advertisers typically contract with RTB advertising companies to deliver a targeted quantity of advertisements over a period of time. For example, a contract may specify that 3,000,000 advertisements are to be displayed over a 30 day period. In another example, a contract may specify a number of user events such as 100,000 clicks on the advertisement impressions over a specified period of time. In another example, a contract may specify that 100,000 advertisement impressions are to be served pay day to users who have visited a target web site at least once in the previous 60 days. For simplicity, a contract that specifies 3,000,000 advertisements to be displayed over a 30 day period may indicate that the advertisement impressions are distributed evenly over the 30 day period resulting in a target of 100,000 advertisement impressions for an advertisement campaign each day. While many RTB exchanges can meet the specifications of a contract, there are other constraints, for example, expandable advertisements are not supported on all web sites or a web site does not allow video advertisements longer than a certain period of time (e.g., 15 seconds). Furthermore, advertisers may specify their advertisements to be displayed on a banner at the top of a web page or supply only a few sizes of advertisements, thus limiting the flexibility of the advertisement inventory. Advertisers may also want to protect their brands by restricting the web sites where their advertisements are displayed. With these constraints, RTB advertisers examine a number of potential advertisement impressions to find opportunities to deliver the advertisements.

Once an opportunity is located, an auction takes place with no guarantee that the advertisement is purchased. There is no guarantee that similar opportunities are further offered due to various factors, such as unavailability of selected web sites, altered advertisement sizes due to layout changes of selected web sites, and unavailability of the advertisement inventory on a domain due to a previous purchase. To manage large advertising campaigns in an uncertain environment, advertisers integrate with multiple RTB exchanges, each of which may host auctions in multiple locations. This results in a continuous stream of bidding opportunities at a rate of tens or hundreds of thousands per second. To deal with the continuous stream of bidding opportunities, a geographically distributed set of servers is used to meet the time and scale requirements as described below.

Typical RTB exchanges conduct a large volume of auctions (e.g., thousands of auctions per second). Each auction is a candidate for multiple advertising campaigns. The bidder must determine which campaign, if any, is the best match for the auction. The capacity of a single server is usually unable to determine a large volume of bidding opportunities for multiple advertising campaigns. Therefore, a set of servers is used to evaluate and respond to the volume of bidding opportunities. A RTB control system is often used to intelligently manage a set of bidding servers.

An RTB auction typically requires a short response (e.g., within 50-100 milliseconds) for a bid, otherwise the response is discarded. The time is measured from the RTB exchange's location including intrinsic latency and analysis time. To reduce intrinsic latency, bidders are placed physically close to the RTB exchanges. Therefore, an RTB control system has to manage bidders that are distributed geographically.

For many advertisement campaigns, advertisers use multiple publishers to reach their advertisement goals with targeting criteria such as the number of advertisement impressions. Since each publisher markets its available impressions through a subset of the RTB exchanges, advertisers integrate with multiple RTB exchanges to deliver each campaign. The RTB control system exercises a consolidated campaign delivery control across multiple RTB exchanges.

### SUMMARY

A system and method for combining past user events with real-time user events to respond to advertising opportunities is disclosed. According to one embodiment, a computer-implemented method includes receiving a first plurality of user events that occurred within a first prior time period, receiving a second plurality of user events that has occurred within seconds of real-time, and providing a plurality of desirable user events for consideration of a real-time bidding request based on processing the first plurality of user events and the second plurality of user events.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of the present disclosure.

### BRIEF DESCRIPTION OF THE DRAWINGS

The accompanying figures, which are included as part of the present specification, illustrate the presently preferred embodiments of the present disclosure and together with the general description given above and the detailed description of the preferred embodiments given below serve to explain and teach the principles described herein.

FIG. 1 illustrates an exemplary architecture of the present system, according to one embodiment.

FIG. 2 illustrates an exemplary computer architecture that may be used for the present system, according to one embodiment.

FIG. 3 illustrates a schematic diagram that describes exemplary communication between components of the present system, according to one embodiment.

FIG. 4 illustrates a diagram of exemplary distribution of user events over a wide area network, according to one embodiment.

FIG. 5 illustrates a block diagram of exemplary combination of new user events and past user events in a user event cache within a bidder, according to one embodiment.

FIG. 6 illustrates a block diagram of exemplary combination between new user events and past user events within a user event cache of a bidder, according to one embodiment.

FIG. 7 illustrates another block diagram of exemplary combination between new user events and past user events within a user event cache of a bidder, according to one embodiment.

FIG. 8 illustrates an exemplary process for combining past user events with new user events, according to one embodiment.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

A system and method for combining past user events with real-time user events to respond to advertising opportunities is disclosed. According to one embodiment, a computer-implemented method includes receiving a first plurality of user events that occurred within a first prior time period, receiving a second plurality of user events that has occurred within seconds of real-time, and providing a plurality of desirable user events for consideration of a real-time bidding request based on processing the first plurality of user events and the second plurality of user events.

Each of the features and teachings disclosed herein can be utilized separately or in conjunction with other features and teachings to provide a system and method for combining past user events with real-time user events to rapidly respond to advertising opportunities. Representative examples utilizing many of these additional features and teachings, both separately and in combination are described in further detail with reference to the attached figures. This detailed description is merely intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. The steps are not intended to be performed in a specific sequential manner unless specifically designated as such.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The methods or algorithms presented herein are not inherently related to any particular computer or other apparatus. Various general purpose systems, computer servers, or personal computers may be used with programs in accordance with the teachings herein, or it may prove convenient to construct a more specialized apparatus to perform the method steps. The structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

According to one embodiment, the present system and method combines past user events with current user events in an efficient and timely manner to improve advertising campaign bidding performance. Past user events take time to be updated and transmitted to bidders. Therefore, there is a time gap (e.g., several minutes) between the time a user event occurs and the time a bidder gets access to that user event. The present system and method combines past user events and real-time user events efficiently so that a response to a bidding request can be based on the combination of past user events and real-time user events within seconds of the occurrence of a real-time user event.

According to one embodiment, the present system and method combines past user activity with real-time user activity for use during bidding. The present system includes an event tracker that receives a user event such as an indication in real-time that a user has accessed a web page (e.g., an instrumented web site) from the user's web browser. The event tracker may receive other user events that indicate an active or passive action that a user provides to a web page, and/or in response to an advertisement. For example, a user event is an indication that a user has completed a confirmation form in a web page. In another example, a user event is an indication that a user has navigated through multiple web pages that is associated with an advertisement impression. According to one embodiment, the present system is unaware of the actual user's identity, i.e., the user is known anonymously. The present system receives an anonymous user identifier based on a browser cookie that is stored in the user's browser while the user is accessing a web page. The user identifier may be valid for an indeterminate period of time depending on how long the user's browser retains the browser cookie containing the user identifier. The present system may receive a user identifier that includes, but is not limited to, an IP address, an embedded user identifier in an Uniform Resource Locator (URL), and an Identifier provided by a bidding exchange.

According to one embodiment, the present system further includes an event processor that receives user events providing indications of users visiting a web page within the same time span (e.g., within the same second) through a message broker. The event processor compares the user events from the event tracker against a user event cache of user events and discards duplicate events as well as events that are of no interest to bidders, while organizing and aggregating interesting user events into messages that are optimal for bidder consumption. According to one embodiment, the interesting user events are based on events that affect the performance of an advertisement campaign. If the present system receives user events while an advertisement campaign is not being run, these user events are an indication of events that are of no interest to bidders. The event processor organizes the interesting user events into multiple lists, where each list includes users for each user event type based on a bidder-specific protocol. According to one embodiment, the bidder-specific protocol is a Transmission Control Protocol/Internet Protocol (TCP/IP) that sends and receives bytes of data in a particular sequence. The event processor further time-stamps lists of user events that belong to a particular time bin (time span). The event processor further broadcasts these messages through the message broker to bidders in multiple remote data centers. This shortens the time (e.g., a few seconds) to communicate real-time user events to potential bidders. The bidders combine these real-time events with past user events (e.g., thirty to ninety minutes past real-time).

According to one embodiment, the event tracker logs user events as they occur into periodic (e.g., hourly) event logs. These periodic event logs are processed by an analyzer that merges user events that have occurred within a first prior time period (e.g., the past hour) with user events that have occurred over a second prior time period (e.g., the past sixty days before the past hour) and discards duplicate user events to produce a file representing interesting past user events.

According to one embodiment, the analyzer merges the past hour of user events with user events from every hour of the past sixty days before the past hour and discards duplicate user events. For example, if the past hour of user events includes event A and event B, and the user events from every hour of the past sixty days includes event A and event C, the analyzer retains event B and event C but discards duplicate event A. The analyzer removes the time-stamp corresponding to each user event and provides an overall timestamp of the first time period to the file i.e., the past hour. The file generated by the analyzer includes an association between a user event identifier with a user. These files may be large and require several minutes to create and transmit to the bidders. The analyzer provides the bidders with past user events of a particular time period that is older than real-time (e.g., thirty to ninety minutes old). Since the analyzer maintains all user event history, the present system can recover from a system failure more quickly than a traditional real-time event system by reloading a state from analyzer event history files instead of requiring a message broker to redeliver messages that occurred over the prior period (e.g., the past sixty days). Thus, the present system reduces the burden on the message broker, as well as tolerating intermittent communication failures and requiring only transitory message storage on each message broker. According to one embodiment, each message is based on a message sequence number so that two message brokers can begin to communicate based on a message sequence number that was last received. If a system error results in lost real-time user event messages due to a system failure, the analyzer corrects the error within a specified period of time (e.g., within thirty to ninety minutes). In this manner, the present system provides two complementing approaches of updating bidders where the analyzer is more reliable over a long term, and the event processor is timelier.

As a consequence, when a bidder receives a real-time bidding (RTB) request for a user, the bidder can consider the desirability of the user based on real-time user events, instead of only considering the past user events that have occurred a particular time period older than real-time (e.g., thirty to ninety minutes prior to real-time). Since the probability of receiving an indication of the same anonymous user visiting a web page diminishes over time (e.g., a user may create a user session on a web browser of a computer for a period of time, close the web browser, and proceed to another user session on a web browser of another computer), the present system provides real-time user events to increase the probability of receiving an indication of the same anonymous user visiting a web page before the identity of the anonymous user changes to another anonymous user. The present system receives an anonymous user identifier of a user based on a browser cookie that is stored in the user's browser while the user is accessing a web page, according to one embodiment. This increases the overall size of a user pool for consideration of user desirability by the bidder before deciding to bid on an RTB request. The bidder can further consider other factors before deciding to bid on an RTB request, including, but not limited to, the geographic location of the user, the publisher, the location of the advertisement impression, and the dimensions of the advertisement impression.

According to one embodiment, the present system includes the following exemplary components for performing the various logical functions described herein. The components are (1) an analyzer, (2) a bidder, (3) a configuration, (4) an event processor, (5) an event tracker, (6) a message broker, (7) a user event cache, and (8) a wide area network. Each is described in turn below:

(1) Analyzer: The analyzer stores user events from event tracker logs and builds user event files for a user event cache on a periodic basis.

(2) Bidder: The bidder responds to opportunities advertised by a RTB exchange.

(3) Configuration: The configuration includes advertisement campaign information that determines events that are of interest to the bidders.

(3) Event processor: The event processor receives aggregates and filters events for transmission to other components.

(4) Event tracker: The event tracker records user events such as when a user visits a web page.

(5) Message broker: The message broker queues and forwards messages between components across a network.

(6) User event cache: The user event cache is a memory cache that stores user event information and provides updates and queries of user event information by other components.

(7) Wide area network: The wide area network is a networking component that transmits data over a distance, and between different local area networks, characterized by lower bandwidth and higher latency than that found in local area networks.

It is contemplated that the above-mentioned exemplary components may be combined or divided into sub-components, and that the components may be implemented using software elements, hardware elements, or a combination of software and hardware elements to perform the various logical functions described herein. Such variations are within the scope of the present subject matter.

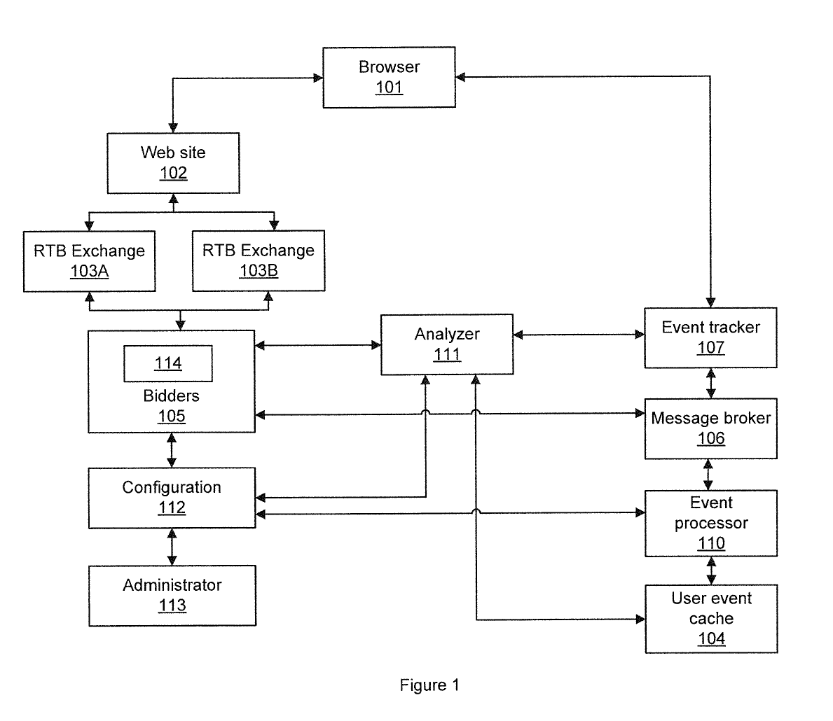

FIG. 1 illustrates an exemplary architecture of the present system, according to one embodiment. Bidders 105 are connected to RTB exchanges 103A and 103B to compete for available impressions for delivery via a web site 102 to a browser 101. Although FIG. 1 only illustrates one browser 101 and two RTB exchanges 103A and 103B, it is understood that the present system can support any number of browsers and any number of RTB exchanges connected to the bidders 105. The bidders 105 may be physically located near the servers of the RTB exchanges 103A and 103B to reduce network latency. The bidders 105 compare each available impression against a real-time active campaign to determine whether to attempt to purchase the impression based, in part, on past user activity.

An analyzer 111 retrieves user event logs from an event tracker 107 on a periodic (e.g., hourly) basis to update the bidders 105 with user activity at a particular period of time after the user activity occurs in real-time. For example, the analyzer 111 updates the bidders 105 thirty to ninety minutes after the user event occurs in real-time. The analyzer 111 determines past user events by comparing user events from a user event log of a first prior time period (e.g., the past hour) against user events that have occurred between a second prior time period (e.g., the past sixty days) and the first prior time period (e.g., the past hour). The past user events indicate a set of users that have not visited a web page between the second prior time period and the first prior time period. The analyzer 111 further adds these past user events to a user event cache 104.

To provide real-time user events in a timelier manner, the event tracker 107 sends messages in a queue containing the real-time user events to a message broker 106. An event processor 110 retrieves these messages from the message broker 106, and discards user events that are not interesting to the bidders 105 according to a configuration 112 and retains user events that are interesting to the bidders 105. The event processor 110 filters the interesting user events against user events in the user event cache 104 and retains new and interesting user events that are not included in the user event cache 104. According to one embodiment, the user event cache 104 stores the past user events from the analyzer 111, i.e., a set of users that have not visited a web page within the second prior time period (e.g., the past sixty days). Thus, a new and interesting user event indicates that the user who has visited a desired web page that is of interest to the bidders and that the user has not visited the web page within the second prior time period (e.g., the past sixty days). It is contemplated that the user event cache 104 may store the number of times a user has visited a web page. It is further contemplated that the user event cache 104 stores the time that a user visits a web page. The event processor 110 provides the bidders 105 with new and interesting user events via the message broker 106. According to one embodiment, the analyzer 111 updates the user event cache 104 at the same frequency as updating a user event cache 114 inside the bidders 105.

If the retained user event is new to the user event cache 104, the user event cache 104 stores the new user event, e.g., user event A. When the event processor 110 provides subsequent requests to the user event cache 104, the user event cache 104 indicates that subsequent retained user events that are similar to or the same as user event A are discarded, under an assumption that the bidders 105 have been successfully updated by the event processor 110 previously. According to one embodiment, the user event cache 104 updates an existing user event in the user event cache 104 with the retained user event. In another embodiment, the user event cache 104 replaces an existing user event in the user event cache 104 with the retained user event.

The configuration 112 provides advertisement campaign settings to the analyzer 111 and the event processor 110 regarding user events that are interesting to the ongoing bidding activity, such as advertisement placement information and geo-targeting information. According to one embodiment, the configuration 112 provides desired event identifiers of desired web pages that are associated with active advertisement campaigns. The event identifiers are retrieved from the configuration 112 via a web service by the analyzer 111 and the event processor 110. An event identifier is assigned to one or more instrumented web pages so that the present system receives a user event by associating an anonymous user identifier (e.g., a browser cookie) with an event identifier. In one embodiment, the event identifier is a number. The configuration 112 provides a desired system behavior and supplemental information required to achieve the desired behavior, such as user events that are of interest to the bidders 105. An administrator 113 can configure the advertisement campaign information of the configuration 112 to inform both the analyzer 111 and the event processor 110 what user events are interesting and are to be retained.

Since user event information may be transmitted over a wide area network, the analyzer 111 and the event processor 110 provide only user events that are interesting to the bidders 105 to reduce bandwidth requirements. The event processor 110 further provides only new user events to keep a minimum real-time feedback necessary to achieve a goal of informing the bidders 105 of new and interesting user activity as quickly as possible.

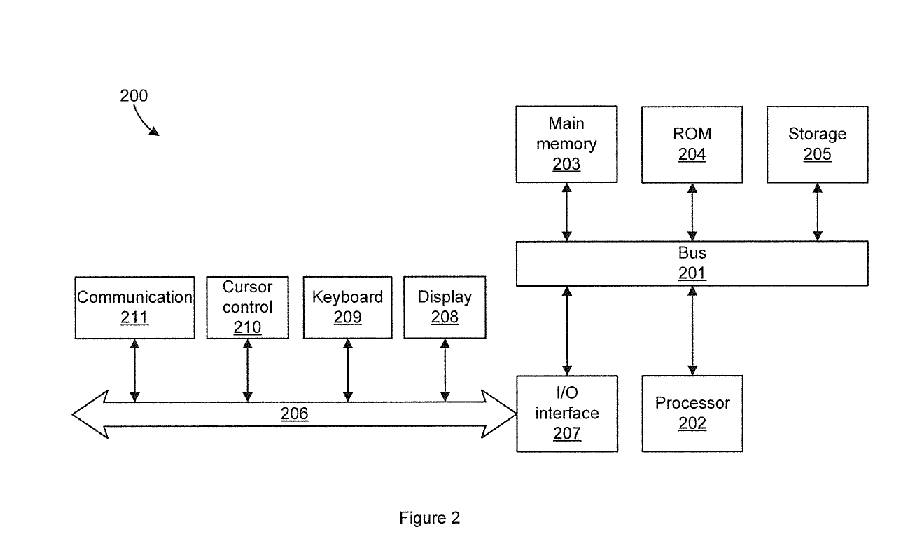

FIG. 2 illustrates an exemplary computer architecture that may be used for the present system, according to one embodiment. The exemplary computer architecture may be used for implementing one or more components described in the present disclosure including, but not limited to, the present system. One embodiment of architecture 200 includes a system bus 201 for communicating information, and a processor 202 coupled to bus 201 for processing information. Architecture 200 further includes a random access memory (RAM) or other dynamic storage device 203 (referred to herein as main memory), coupled to bus 201 for storing information and instructions to be executed by processor 202. Main memory 203 also may be used for storing temporary variables or other intermediate information during execution of instructions by processor 202. Architecture 200 may also include a read only memory (ROM) and/or other static storage device 204 coupled to bus 201 for storing static information and instructions used by processor 202.

A data storage device 205 such as a magnetic disk or optical disc and its corresponding drive may also be coupled to architecture 200 for storing information and instructions. Architecture 200 can also be coupled to a second I/O bus 206 via an I/O interface 207. A plurality of I/O devices may be coupled to I/O bus 206, including a display device 208, an input device (e.g., an alphanumeric input device 209 and/or a cursor control device 210).

The communication device 211 allows for access to other computers (e.g., servers or clients) via a network. The communication device 211 may include one or more modems, network interface cards, wireless network interfaces or other interface devices, such as those used for coupling to Ethernet, token ring, or other types of networks.

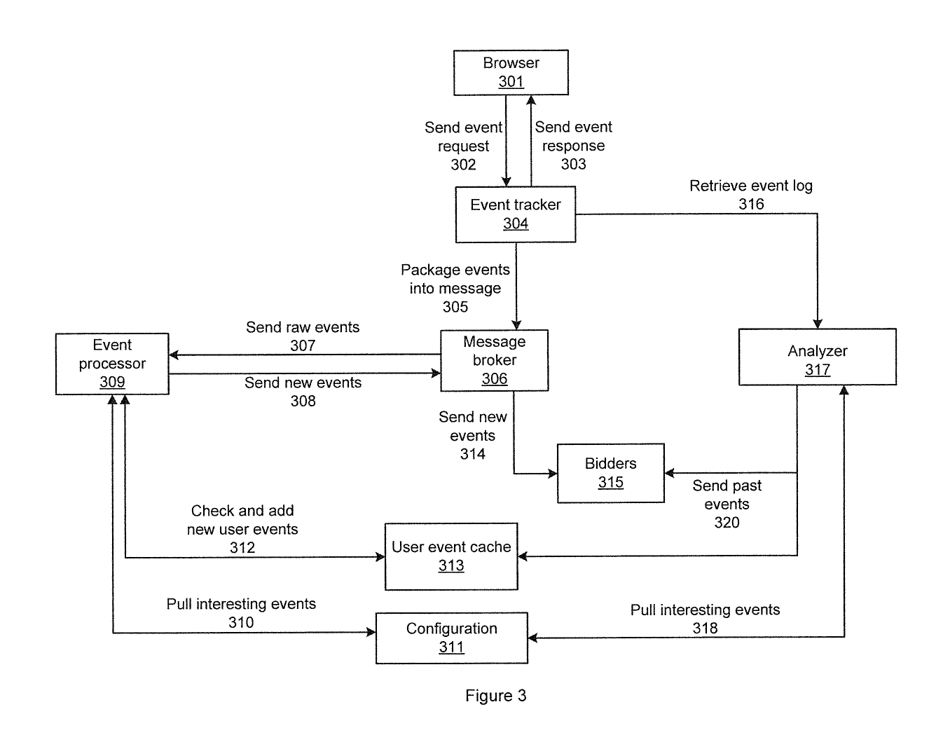

FIG. 3 illustrates a schematic diagram that describes exemplary communication between components of the present system, according to one embodiment. At 302, a browser 301 of a user, as part of rendering an instrumented web page, sends an event request to an event tracker 304. The browser provides an event request to render a transparent image, one pixel high and wide having no effect on the web page appearance, from the event tracker 304. The transparent image makes up a portion of a graphical user display of the browser and contains web page information. The event request includes a request that identifies the user and an indication that the user has visited a specific web page. At 303, the event tracker 304 provides an event response that includes the requested transparent image to the browser 301. The event request further includes a numeric event identifier. According to one embodiment, the event tracker 304 converts the event request to a numeric event identifier. The event tracker 304 creates a user event that associates the user (e.g., a browser cookie) with the numeric event identifier supplied by the event request, or any other web pages sharing the same numeric event identifier.

The event tracker 304 further records the raw user events to a periodic (e.g., hourly) event log. At 305, the event tracker 304 packages the raw user events into a message and posts a message queue to a message broker 306.

At 307, an event processor 309 retrieves the message queue of the message broker 306 and processes the raw user events. The event processor 309 is continuously connected to the message broker 306 so that the event processor 309 processes the raw user events as they arrive from the message broker 306. The message broker 306 provides a queue for messages from the event processor 309 so that if the event processor 309 is disconnected (e.g., offline or slow) from the message broker 306, messages can be lined up in the queue. Prior to retrieving the raw events from the message broker 306's queue, at 310, the event processor 309 retrieves a list of events that are of interest to bidders 315 from a configuration 311. The event processor 309 may retrieve a list of interesting events from the configuration 311 any time prior to processing the raw user events. The event processor 309 discards raw user events that are not of interest to the bidders 315 and retains raw user events that are of interest to the bidders 315. At 312, the event processor 309 checks whether the retained interesting user events are the same as user events in a user event cache 313. If a retained interesting user events is not found in the user events in the user event cache 313, the event processor 309 determines the retained interesting user event as a new user event adds the new user event to the user event cache 313.

For example, if a retained interesting user event, user event A, is new to the user event cache 313, the user event cache 313 stores user event A. When the event processor 309 provides a subsequent request to the user event cache 313 to filter subsequently retained interesting user events against user events in the user event cache 313, the user event cache 313 indicates that subsequent retained user events are filtered against user event A, under an assumption that the bidders 315 have been successfully updated by the event processor 313 previously.

At 308, the event processor 309 packages new and interesting user events into a message and posts it to the message broker 306. At 314, the message broker 306 provides a message that includes the new and interesting user events to the bidders 315.

At 316, an analyzer 317 retrieves the periodic event logs from the event tracker 304. For example, the event tracker 304 records raw user events from 8 p.m. to 8:59.59 p.m. into a 9 p.m. event log. The analyzer 317 retrieves the 9 p.m. event log with a particular delay, for example, about ten minutes past 9 p.m. i.e., 9:10 p.m. At 318, the analyzer 317 retrieves the list of interesting events from the configuration 311. This ensures that the event processor 309 and the analyzer 317 consistently retain the same interesting events. The analyzer 317 may retrieve the list of interesting events from the configuration 311 any time prior to retrieving the periodic event logs from the event tracker 304. The configuration 311 provides the analyzer 317 and the event processor 309 with information regarding user events that are interesting to real-time bidding activity.

The analyzer 317 generates reports of past user events by combining user events from the event logs over a particular time period and retaining user events that are interesting to the bidders 315 based on the list of interesting events from the configuration 311. According to one embodiment, the analyzer 317 merges an event log of user events within a first prior time period (e.g., the past hour) with event logs of user events before the first prior time period but over a second prior time period (e.g., the previous sixty days) and discards duplicate user events to provide a report that includes an aggregation of past user events. At 320, the analyzer 317 forwards the aggregated past user events to the bidders 315 and to the user event cache 313. According to one embodiment, the analyzer 317 provides an aggregation of past user events that are thirty to ninety minutes old to the bidders 315. For example, the analyzer 317 receives a 9 p.m. event log of user events from 8 p.m. to 8:59.59 p.m. at about 9:10 p.m. If a user event A in the event log occurs at 8 p.m. and the bidders 315 receive the aggregated past user events at about 9:30 p.m., the user event A is about ninety minutes old since the occurrence of the user event A. If a user event B in the event log occurs at 8:59.59 p.m. and the bidders 315 receive the aggregated past user events at about 9:30 p.m., the user event B is about thirty minutes old since the occurrence of the user event B. The analyzer 317 forwards the past user events to the user event cache 313 to ensure that the event processor 309 has access to the same user events that are provided to the bidders 315.

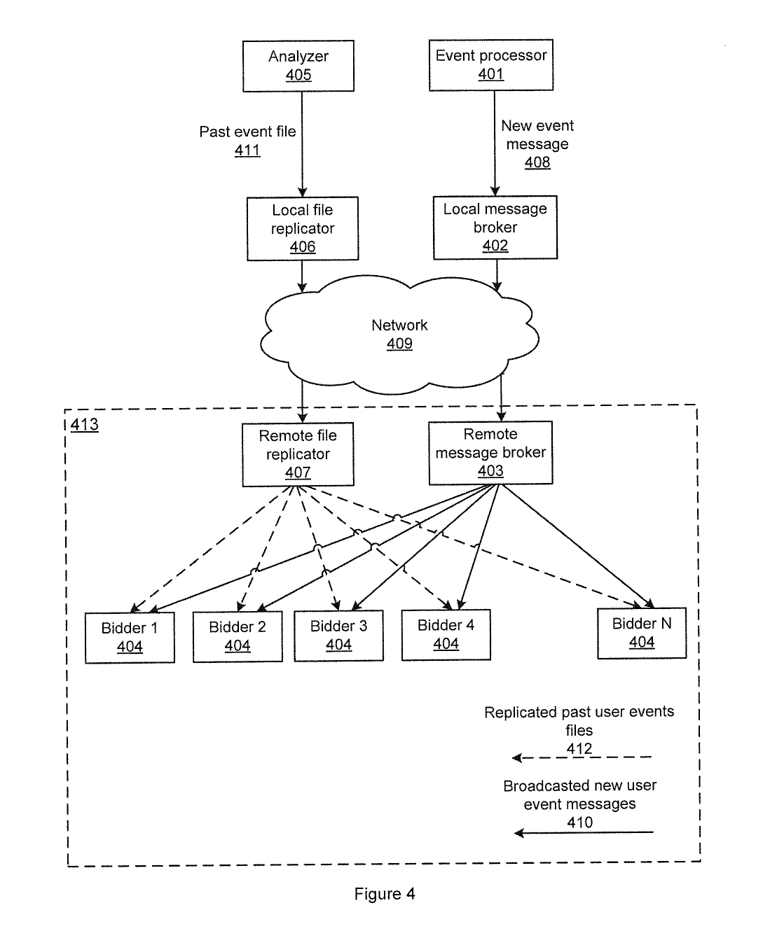

FIG. 4 illustrates a diagram of exemplary distribution of user events over a wide area network, according to one embodiment. An event processor 401 delivers a new user event message 408 to a local message broker 402. The local message broker 402 delivers the new user event message 408 to a remote message broker 403 hosted in a remote data center 413 via a network 409. According to one embodiment, the network 409 may be a limited bandwidth, high latency wide area network. Although FIG. 4 only illustrates one data center 413, the present system may deliver a copy of the new user event message 408 to each data center of multiple data centers. The remote message broker 403 broadcasts new user event messages 410 from the new user event message 408 received via the network 409 to each bidder 404. The remote message broker 403 provides as many copies of the broadcasted new user event messages 410 to as many bidders 404 over the remote data center 413's local area network where excess bandwidth is available.

The analyzer 405 similarly distributes the delivery of a past user event file 411 only after the past user event file 411 arrives at the remote data center 413. The analyzer 405 copies a past user event file 411 on a local file replicator 406. The local file replicator 406 transmits the past user event file 411 to a remote file replicator 407 via the network 409. According to one embodiment, the local file replicator 406 transmits the past user event file 411 to the remote file replicator 407 using various file replication and compression techniques known to one ordinary skilled in the art. The remote file replicator 407 in the remote data center 413 replicates the past user event files 412 to each bidder 404 after the past event file arrives on the remote data center 413's local area network.

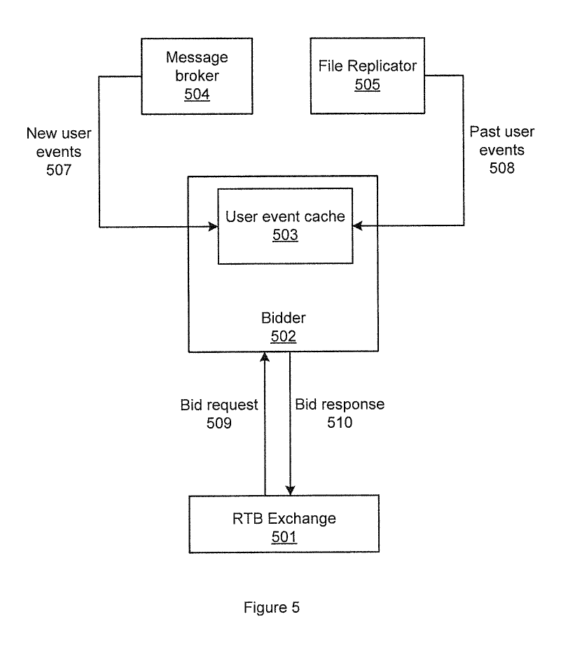

FIG. 5 illustrates a block diagram of exemplary combination of new user events and past user events in a user event cache within a bidder, according to one embodiment. A bidder 502 includes a user event cache 503 that holds past user events 508 and new user events 507. The user event cache 503 rapidly responds to queries on user activity and other factors considered in responding to a bid request 509 from an RTB exchange 501. The other factors considered in responding to the bid request 509 includes, but is not limited to, the geographic location of the user, the web site, the location of the advertisement impression on the web site, and the dimensions of the advertisement impressions. The user event cache 503 receives past user events 508 from a file replicator 505 periodically (e.g., every hour). The past user events 508 are typically thirty to sixty minutes old by the time they are loaded by the user event cache 503.

A message broker 504 delivers new user events 507 periodically (e.g., several times a second) into the user event cache 503. The user event cache 503 combines the past user events 508 and the new user events 507 so that the bidder 502 has access to the user activity available in formulating the bidder 502's bid response 510 to the RTB exchange 501.

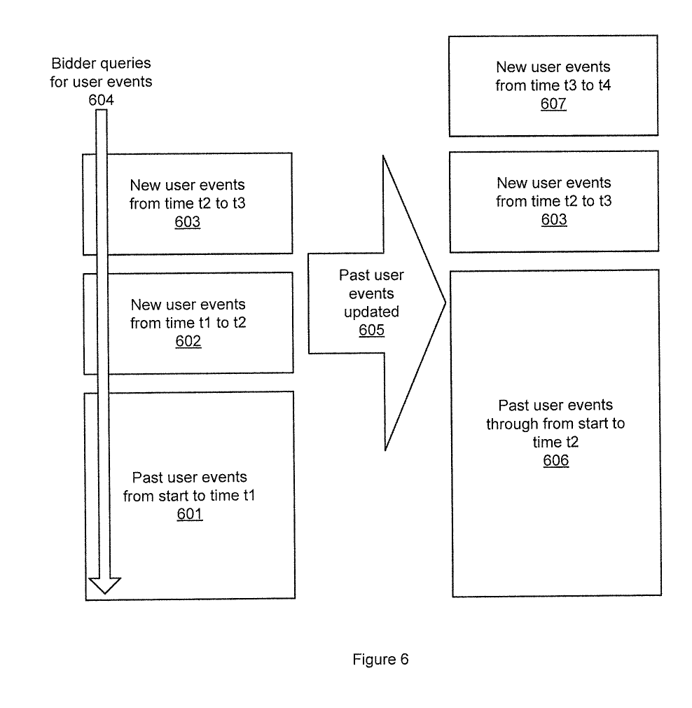

FIG. 6 illustrates a block diagram of exemplary combination between new user events and past user events within a user event cache of a bidder, according to one embodiment. The present system provides time-stamps on past user events to identify the latest clock-aligned hour corresponding to the user events. For example, the present system assigns user events that occur from 8 p.m. to 8:59.59 p.m. to a 9 p.m. time bucket. The present system further assigns user events that occur from 9 p.m. to 9:59.59 pm to a 10 p.m. time bucket. The present system considers past user events from start time to time T1 (601) as the most reliable data available on user events. According to one embodiment, past user events indicate a set of users who has visited a web page within a first prior time period (e.g., the past hour), where the set of users is of a desired user type and has not visited a web page before the first prior time period and within a second prior time period (e.g., the past sixty days). It is understood that any time period indicated as from time A to time B means time A up to, but not including time B. The present system further provides time-stamps to new user events and discards the new user events that occur during a time covered by past events from start time to time T1 (601). According to one embodiment, new user events indicate a set of users who has visited a web page in real-time, where the set of users is of the desired user type and has not visited a web page within the second prior time period (e.g., the past sixty days). When new user events occur between time T1 and T2, the user event cache stores the new user events from time T1 to T2 (602) into a T1 to T2 time bucket created for that time period. When new user events occur between time T2 and T3, the user event cache stores the new events from time T2 to T3 (603) into a T2 to T3 time bucket.

The user event cache updates the past user events (605) periodically (e.g., thirty minutes past the hour). In this embodiment, the user event cache updates the past user events from 601 (start time to time T1) to 606 (start time to time T2). Since the present system considers past user events to be the most reliable data, the user event cache discards new user events from time T1 to T2 (602) that are previously stored. However, the user event cache continues to store the new user events from time T2 to T3 (603) because these new events occur after time T2 (606). The user event cache stores new user events from time T3 to T4 (607) into a T3 to T4 time bucket. For example, the user event cache stores new user events from time T3 to T4 (607) thirty minutes after the arrival of past user events from start to time T2 (606) to receive new user events in real-time. Therefore, the user event cache repeats the above process periodically (e.g., hourly) with the past user events replacing new user events, while additional new user event time buckets are created to capture new real-time user events.

When a bidder provides a request for user events (604), the user event cache returns the most recent user event by examining time T2 to T3 (603), followed by time T1 to T2 (602) and then start time to time T1 (601). If a specified user is not found in the past or new user event records, the present system considers the user not to be associated with the user event. This makes the user less or more desirable during the bidding process. According to one embodiment, the present system considers a user to be more desirable if the user event representing the user has visited a particular web page indicates that the user demonstrates an interest to an advertising campaign. In another embodiment, the present system does not consider the user event for an advertising campaign. In another embodiment, the present system considers a user to be less desirable if the goal of the advertisement campaign is to display an advertisement to a user that has not visited a particular web page.

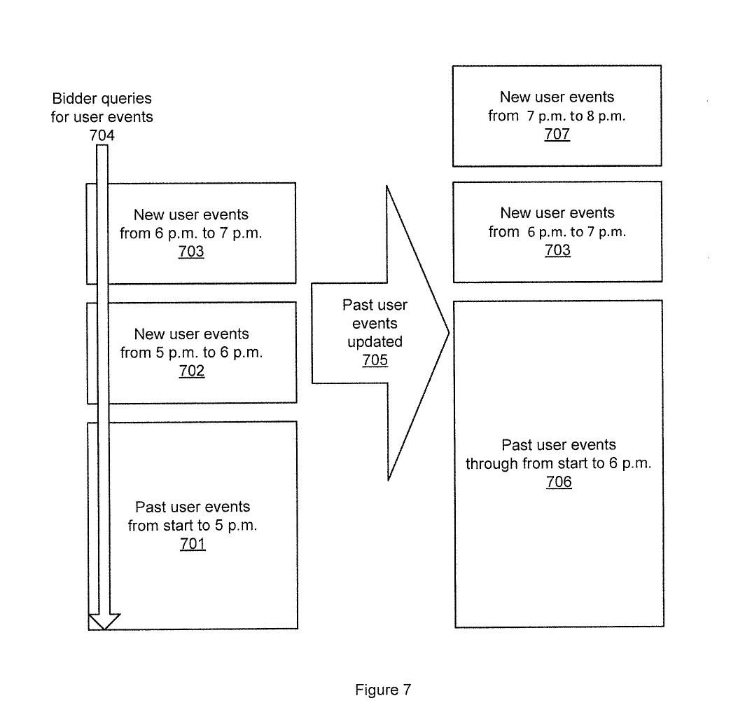

FIG. 7 illustrates another block diagram of exemplary combination between new user events and past user events within a user event cache of a bidder, according to one embodiment. The user event cache updates past user events from a start time to 5 p.m. (701) at 5:30 p.m. Since the present system considers past user events at 701 to be the most reliable, the user event cache discards new user events that occur during the same time i.e., 701. The user event cache stores the new user events that occur from 5 p.m. to 6 p.m. into a 6 p.m. time bucket (702). The user event cache further stores the new events that occur from 6 p.m. to 7 p.m. into a 7 p.m. time bucket (703). When a bidder provides a request for user events (704), the user event cache returns the most recent user event by examining user events in the 7 p.m. time bucket (703), followed by user events in the 6 p.m. time bucket (702) and then user events from start time to 5 p.m. (701).

The user event cache updates the past user events (705) every hour at thirty minutes past the hour. In this case, the user event cache updates the past user events from 701 (start time to 5 p.m.) to 706 (start time to 6 p.m.) at 6:30 p.m. Since the present system considers past user events to be the most reliable data, the user event cache discards new user events from the 6 p.m. time bucket (702) that are previously stored. However, the user event cache continues to store the new user events from the 7 p.m. time bucket (703) because these new events occur after 6 p.m. (706). The user event cache further stores new user events that occur from 7 p.m. to 8 p.m. into an 8 p.m. time bucket (707).

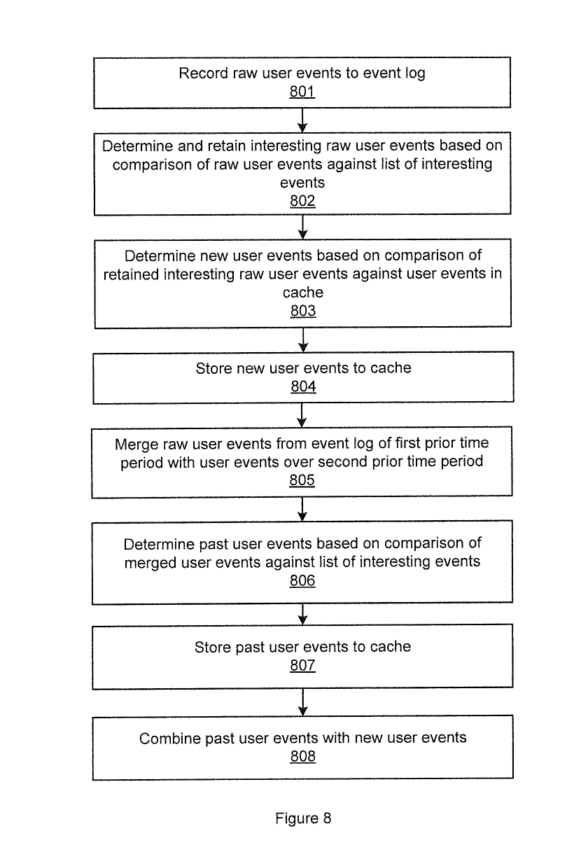

FIG. 8 illustrates an exemplary process for combining past user events with new user events, according to one embodiment. The present system records raw user events to a periodic event log at 801. According to one embodiment, the present system records raw user events indicating that users have visited web pages based on event requests from browsers. The present system determines and retains interesting raw events based on a comparison of the raw user events against a list of interesting user events at 802. According to one embodiment, the list of interesting user events is based on an advertisement campaign configuration of desired event identifiers. The present system further determines new user events based on a comparison of retained interesting raw events against user events in a user event cache at 803. The present system stores the new user events to the user event cache at 804. The present system merges raw user events from the event log of a first prior time period (e.g., the past hour) with user events that occur before the first prior time period and within the second prior time period (e.g., the past sixty days) and discards duplicate user events at 805. The present system determines past user events based on a comparison of the merged user events against the list of interesting events at 806. The present system stores the past user events to the user event cache at 807. The present system combines the past user events with the new user events at 808. It is contemplated that the present system may determine new user events at 802-804 and determine past user events at 805-807 concurrently, or determine past user events at 805-807 prior to determining new user events at 802-804. Such variations are within the scope of the present subject matter.

The above example embodiments have been described hereinabove to illustrate various embodiments of implementing a system and method for combining past user events with real-time user events to rapidly respond to advertising opportunities. Various modifications and departures from the disclosed example embodiments will occur to those having ordinary skill in the art. The subject matter that is intended to be within the scope of the present disclosure is set forth in the following claims.

We claim:

1. A computer-implemented method, comprising:
receiving a first plurality of user events that occurred within a first prior time period;
receiving a second plurality of user events that has occurred within seconds of real-time; and
providing a plurality of desirable user events for consideration of a real-time bidding request based on processing the first plurality of user events and the second plurality of user events.

2. The computer-implemented method of claim 1, wherein processing the first plurality of user events comprises determining a first set of user events from the first plurality of user events, wherein the first set of user events has not occurred before in the first prior time period.

3. The computer-implemented method of claim 2, wherein processing the second plurality of user events comprises determining a second set of user events from the second plurality of user events, wherein the second set of user events does not include the first set of user events.

4. The computer-implemented method of claim 1, wherein a user event of the first plurality of user events and the second plurality of user events comprises an indication that a user has provided an interaction with a web page.

5. The computer-implemented method of claim 1, wherein a user event of the first plurality of user events and the second plurality of user events is based on a desired event identifier.

6. The computer-implemented method of claim 4, wherein the indication comprises associating a user identity with an event identifier, wherein the user identity comprises one or more of a browser cookie, an Internet Protocol address, an embedded user identifier in an Uniform Resource Locator, and an identifier provided by a bidding exchange.

7. The computer-implemented method of claim 2, wherein the first prior time period is a prior sixty days to real-time.

8. The computer-implemented method of claim 1, further comprising adding the processed second plurality of user events to the processed first plurality of user events.

9. The computer-implemented method of claim 1, further comprising updating the processed first plurality of user events with the processed second plurality of user events.

10. The computer-implemented method of claim 1, further comprising replacing the processed first plurality of user events with the processed second plurality of user events.

11. The computer-implemented method of claim 1, wherein providing the plurality of desirable user events is based on:
determining the processed first plurality of user events that has occurred from a start time of a desired prior time span to a time prior to an end time of the desired prior time span; and
determining the processed second plurality of user events that has occurred from the end time of the desired prior time span to real-time.

12. The computer-implemented method of claim 1, further comprising:
organizing the processed first plurality of user events into a file; and
replicating the file to each bidder of a plurality of bidders.

13. The computer-implemented method of claim 1, further comprising:
organizing the processed second plurality of user events into a message; and
broadcasting the message to each bidder of a plurality of bidders based on a bidder-specific protocol.

14. An apparatus, comprising:
an event tracker that receives a first plurality of user events that occurred within a first prior time period, wherein the event tracker receives a second plurality of user events that has occurred within seconds of real-time;
an analyzer that processes the first plurality of user events received from the event tracker;
an event processor that processes the second plurality of user events received from the event tracker; and
a bidder that receives a plurality of desirable user events for consideration of a real-time bidding request based on the processed first plurality of user events received from the analyzer and the processed second plurality of user events received from the event processor.

15. The apparatus of claim 14, wherein the analyzer determines a first set of user events from the first plurality of user events, wherein the first set of user events has not occurred before in the first prior time period.

16. The apparatus of claim 15, wherein the event processor determines a second set of user events from the second plurality of user events, wherein the second set of user events does not include the first set of user events.

17. The apparatus of claim 14, wherein a user event of the first plurality of user events and the second plurality of user events comprises an indication that a user has provided an interaction with a web page.

18. The apparatus of claim 14, wherein a user event of the first plurality of user events and the second plurality of user events is based on a desired event identifier.

19. The apparatus of claim 17, wherein the indication comprises an association of a user identity with an event identifier, wherein the user identity comprises one or more of a browser cookie, an Internet Protocol address, an embedded user identifier in an Uniform Resource Locator, and an identifier provided by a bidding exchange.

20. The apparatus of claim 15, wherein the first prior time period is a prior sixty days to before real-time.

21. The apparatus of claim 14, further comprising a cache that stores the processed first plurality of user events and the processed second plurality of user events.

22. The apparatus of claim 14, further comprising a cache that updates the processed first plurality of user events with the processed second plurality of user events.

23. The apparatus of claim 14, further comprising a cache that replaces the processed first plurality of user events with the processed second plurality of user events.

24. The apparatus of claim 14, wherein the bidder that receives the plurality of desirable user events further comprises the bidder:
determines the processed first plurality of user events that has occurred from a start time of a desired prior time span to a time prior to an end time of the desired prior time span; and
determines the processed second plurality of user events that has occurred from the end time of the desired prior time span to current time.

25. The apparatus of claim 14, further comprising a file replicator that:
receives a file from the analyzer, wherein the analyzer organizes the processed first plurality of user events into the file; and
replicates the file to each bidder of a plurality of bidders.

26. The apparatus of claim 14, further comprising a message broker that:
receives a message from the event processor, wherein the event processor organizes the processed second plurality of user events into the message;
broadcasts the message to each bidder of a plurality of bidders based on a bidder-specific protocol.

27. A non-transitory computer readable medium containing computer-readable instructions stored therein for causing a computer processor to perform operations comprising:
receive a first plurality of user events that occurred within a first prior time period;
receive a second plurality of user events that has occurred within seconds of real-time; and
provide a plurality of desirable user events for consideration of a real-time bidding request based on processing the first plurality of user events and the second plurality of user events.

28. The non-transitory computer readable medium of claim 27, wherein the computer processor performs the operations to determine a first set of user events from the first plurality of user events, wherein the first set of user events has not occurred before in the first prior time period.

29. The non-transitory computer readable medium of claim 28, wherein the computer processor performs the operations to determine a second set of user events from the second plurality of user events, wherein the second set of user events does not include the first set of user events.

30. The non-transitory computer readable medium of claim 27, wherein a user event of the first plurality of user events and the second plurality of user events comprises an indication that a user has provided an interaction with a web page.

31. The non-transitory computer readable medium of claim 27, wherein a user event of the first plurality of user events and the second plurality of user events is based on a desired event identifier.

32. The non-transitory computer readable medium of claim 30, wherein the indication comprises an association of a user identity with an event identifier, wherein the user identity comprises one or more of a browser cookie, an Internet Protocol address, an embedded user identifier in an Uniform Resource Locator, and an identifier provided by a bidding exchange.

33. The non-transitory computer readable medium of claim 28, wherein the first prior time period is a prior sixty days to real-time.

34. The non-transitory computer readable medium of claim 27, wherein the computer processor performs the operations to add the processed second plurality of user events to the processed first plurality of user events.

35. The non-transitory computer readable medium of claim 27, wherein the computer processor performs the operations to update the processed first plurality of user events with the processed second plurality of user events.

36. The non-transitory computer readable medium of claim 27, wherein the computer processor performs the operations to replace the processed first plurality of user events with the processed second plurality of user events.

37. The non-transitory computer readable medium of claim 27, wherein the computer processor performs the operations to:
determine the processed first plurality of user events that has occurred from a start time of a desired prior time span to a time prior to an end time of the desired prior time span; and
determine the processed second plurality of user events that has occurred from the end time of the desired prior time span to current time.

38. The non-transitory computer readable medium of claim 27, wherein the computer processor performs the operations to:
organize the processed first plurality of user events into a file; and
replicate the file to each bidder of a plurality of bidders.

39. The non-transitory computer readable medium of claim 27, wherein the computer processor performs the operations to:
organize the processed second plurality of user events into a message;
broadcasts the message to each bidder of a plurality of bidders based on a bidder-specific protocol.
